(19) United States
(12) Patent Application Publication
(10) Pub. No.: US 2025/0355286 A1
(43) Pub. Date: Nov. 20, 2025

(54) OPTICAL DEVICE AND METHOD OF MANUFACTURE

(71) Applicant: Taiwan Semiconductor Manufacturing Co., Ltd., Hsinchu (TW)

(72) Inventors: Cheng-Tse Tang, Hsinchu (TW); Hau-Yan Lu, Hsinchu (TW); Wei-Kang Liu, Taichung City (TW); Yingkit Felix Tsui, Cupertino, CA (US)

(21) Appl. No.: 19/283,561

(22) Filed: Jul. 29, 2025

Related U.S. Application Data
(63) Continuation of application No. 18/765,060, filed on Jul. 5, 2024.
(60) Provisional application No. 63/637,026, filed on Apr. 22, 2024.

(51) Int. Cl. G02F 1/025; G02F 1/01

(52) U.S. Cl. CPC G02F 1/025; G02F 1/0136

(57) ABSTRACT

Optical devices and methods of manufacture are presented in which a first photonic device comprises a rotator section and a splitter section. The rotator section comprises multiple slabs, such as a first slab and a second slab, with different thicknesses. The splitter section comprises a first waveguide and a second waveguide coupled to the first waveguide.

### PRIORITY CLAIM AND CROSS-REFERENCE

This application is a continuation of U.S. patent application Ser. No. 18/765,060, filed Jul. 5, 2024, which application claims the benefit of U.S. Provisional Application No. 63/637,026, filed on Apr. 22, 2024, which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a silicon on insulator, in accordance with some embodiments.

FIG. 2 illustrates a first step in forming first optical components, in accordance with some embodiments.

FIG. 3A illustrates a second step in forming the first optical components, in accordance with some embodiments.

FIGS. 3B-3F illustrate a first optical device, in accordance with some embodiments.

FIG. 4 illustrates a first dielectric layer, in accordance with some embodiments.

FIG. 5 illustrates a first metallization layer, in accordance with some embodiments.

FIG. 6 illustrates a first semiconductor device, in accordance with some embodiments.

FIG. 7 illustrates a support substrate, in accordance with some embodiments.

FIG. 8 illustrates backside optical components, in accordance with some embodiments.

FIG. 9 illustrates external connections, in accordance with some embodiments.

FIGS. 10A-10B illustrate an embodiment of the first optical device with tapered interfaces, in accordance with some embodiments.

FIG. 11 illustrates an embodiment of the first optical device without tapered interfaces, in accordance with some embodiments.

FIG. 12 illustrates an embodiment of the first optical device without a diamond shaped slab and tapered interfaces, in accordance with some embodiments.

FIG. 13 illustrates an embodiment of the first optical device without a diamond shaped slab and without tapered interfaces, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a multiple depth polarization beam splitter and rotator are used in order to suppress transverse magnetic (TM) mode in optical signals. The disclosures herein may be particularly applicable in silicon photonic platforms, such as silicon photonic applications such as a transceiver in a data center, biosensors in medicine, LiDAR in automobiles, gyroscopes in defense or space industries, optical interposers, 3DIC integration, combinations of these, or the like. The embodiments presented, however, are intended to be illustrative and are not intended to limit the ideas presented to the precise embodiments described. Rather, the ideas presented may be incorporated into a wide variety of embodiments, and all such embodiments may be included within the overall scope of the disclosure.

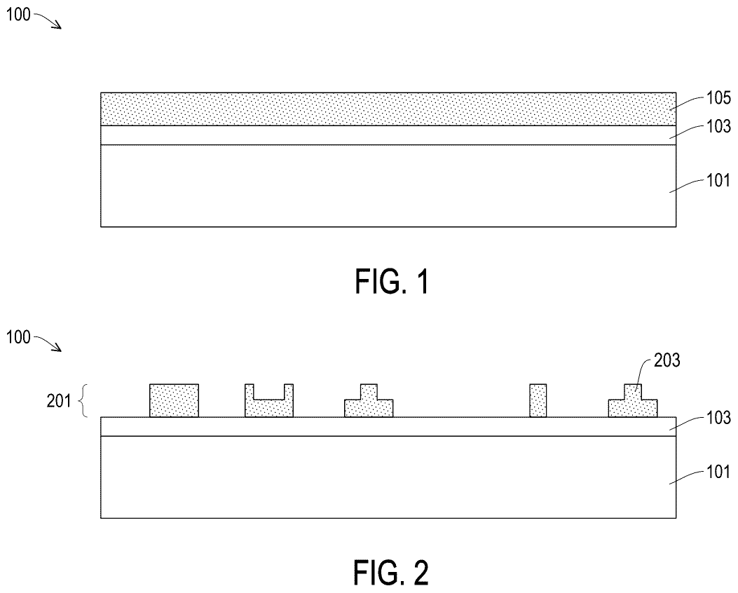

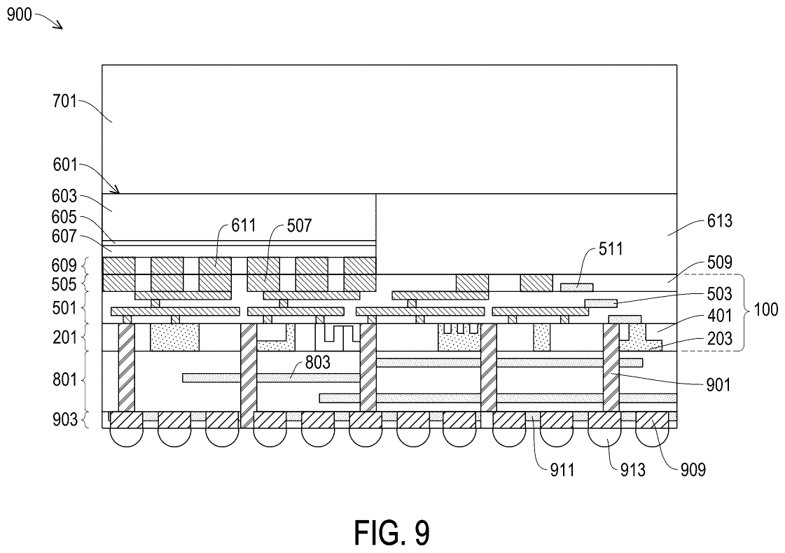

With reference now to FIG. 1, there is illustrated an initial structure of an optical interposer 100 (seen in FIG. 9), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the one or more photolithographic masking and etching processes may be all or at least most of the manufacturing that is used to form these first optical components 203.

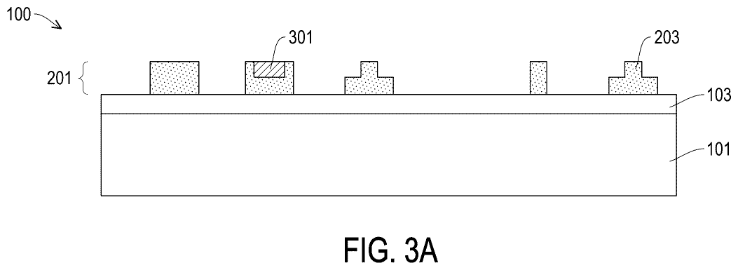

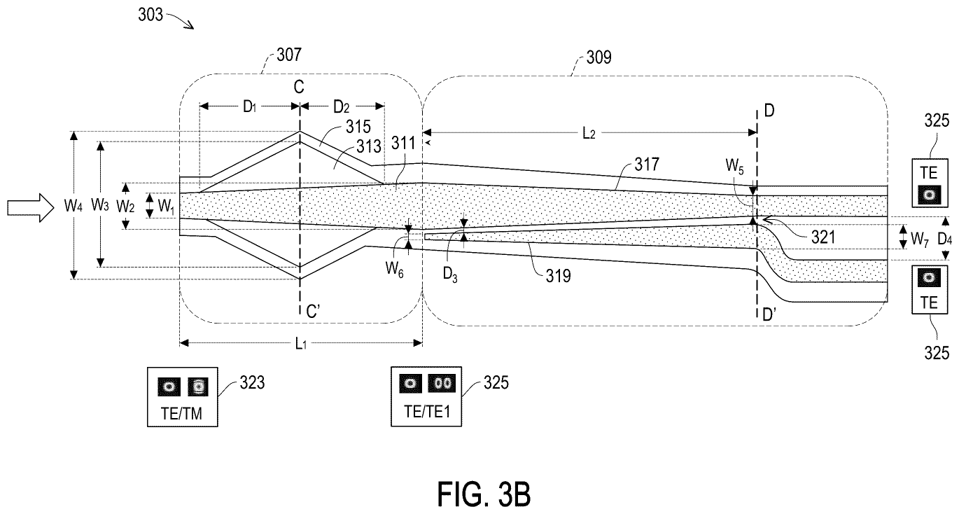

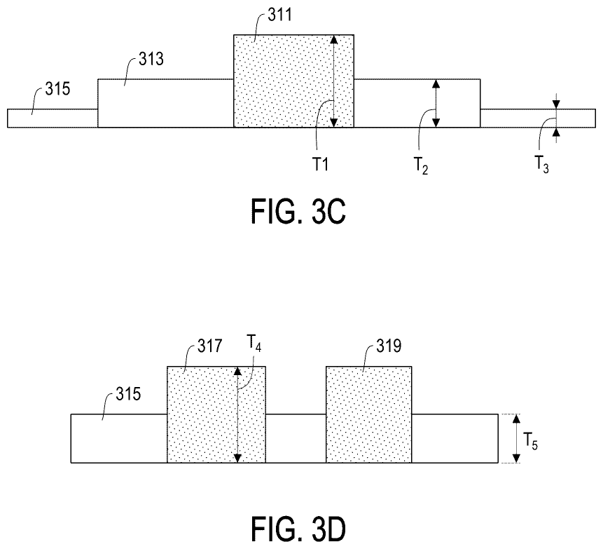

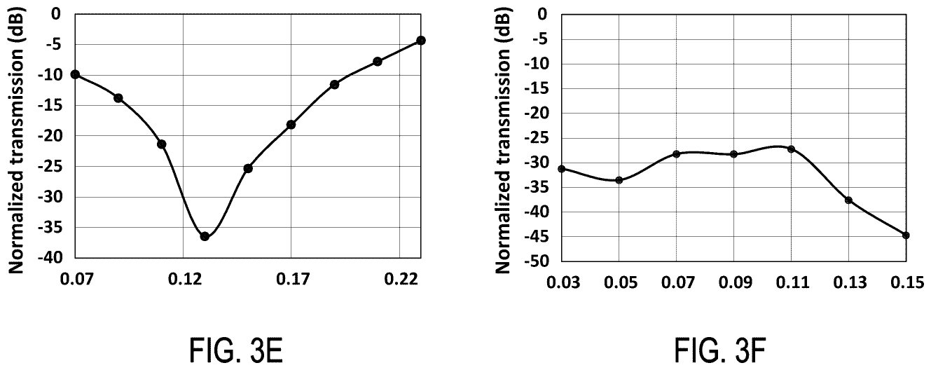

FIG. 3A illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3A, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 3B illustrates a top down view of a particular first photonic device 303 of the first optical components 203 formed in the first active layer 201 which may be utilized to receive optical signals (not separately illustrated in FIG. 3A) having both a transverse electric (TE) and a transverse magnetic (TM) mode, convert the TM mode in the light source to TE mode, and split the light source. In the particular embodiment illustrated in FIG. 3B, the first photonic device 303 comprises a rotator section 307 and a splitter section 309. However, any other suitable sections may be used in addition to these sections.

Looking first at the rotator section 307, the rotator section 307 is utilized in order to receive optical signals from an attached receiver or waveguide (represented in FIG. 3B by the arrow to the left of the rotator section 307) and convert the optical signals. In particular, the optical signals at the point of entrance may have both TE and TM modes, which is undesired. The rotator section 307 receives this multi-mode signal and converts the TM mode into TE modes, so that as the converted optical signal exits the rotator section 307 into the splitter section 309 there is only TE mode remaining (although there may still be some residual TM mode still present).

FIG. 3C illustrates a cross-sectional view of the rotator section 307 in FIG. 3B through line C-C′. As can be seen in the embodiment illustrated in FIG. 3C, the rotator section 307 comprises a first slab 311, a second slab 313, and a third slab 315. Looking first at the first slab 311 in the middle, the first slab 311 comprises the core material (e.g., silicon) and receives the optical signals from the adjacent waveguide. In an embodiment, the first slab 311 may have a first thickness T₁ of between about 10 nm and about 10 μm, such as between about 50 nm and about 500 nm, and a first length L₁ (seen in FIG. 3B) of between about 1 μm and about 5 mm. However, any suitable dimensions may be utilized.

Additionally, the first slab 311 may have the tapered shape as the first slab 311 extends from one side where the optical signals enter the rotator section 307 to another side where the optical signals exit the rotator section 307. In a particular embodiment the first slab 311 may have a first width W₁ at the side the optical signal enter of between about 10 nm and about 10 μm, such as a few hundred nanometers, while the first slab 311 may have a second width W₂ at the side the optical signals exit that is larger than the first width, such as between about 10 nm and about 10 μm, such as a few hundred nanometers.

Looking next at the second slab 313, the second slab 313 is located around a central portion of the first slab 311, and has a smaller thickness than the first slab 311. In a particular embodiment the second slab 313 may have a second thickness T₂ of between about 10 nm and about 10 μm, such as between about 50 nm and about 500 nm. However, any suitable thickness may be utilized.

Additionally, the second slab 313 may be made from a similar material as the first slab 311. In such an embodiment the second slab 313 may be formed using a separate photolithographic masking and etching process from the first slab 311, or else may be formed using a combination of masking and etching processes that are also used to form the first slab 311. Any suitable combination of processes may be used to form the second slab 313.

In another embodiment the second slab 313 may be formed using a different material than the first slab 311. For example, in embodiments in which the first slab 311 comprises silicon, the second slab 313 may be a material such as silicon (Si), silicon nitride (SiN), polyimide, combinations of these, or the like. In such an embodiment the first slab 311 may be formed first as described above, and then the material for the second slab 313 may be deposited using a process such as chemical vapor deposition, physical vapor deposition, or atomic layer deposition, and patterning using one or more photolithographic masking and etching processes. However, any suitable materials and processes may be utilized.

Additionally, as best seen in the top-down view of FIG. 3B, the second slab 313 may have a diamond shape around the first slab 311, with tapered sides on both sides of an interface of the sidewalls (located in FIG. 3B where line C-C′ is) of the second slab 313. In an embodiment the second slab 313 may extend away from the interface of the sidewalls of the second slab 313 a first distance D₁ of between about 1 μm and about 5 mm, and may vary between about 50 μm and about 200 μm. Additionally, the second slab 313 may also extend away from the interface of the sidewalls of the second slab 313 a second distance D₂ of between about 1 μm and about 5 mm, such as less than about 100 μm. Finally, at the interface of the sidewalls, the second slab 313 may have a third width W₃ of between about 10 nm and about 10 μm, such as a few micrometers. However, any suitable dimensions may be utilized.

Looking next at the third slab 315, the third slab 315 is located around both the first slab 311 and the second slab 313, and generally follows the external sides of the first slab 311 and the second slab 313. In a particular embodiment the third slab 315 may have a third thickness T₃ of between about 10 nm and about 10 μm, such as between about 50 nm and about 500 nm. However, any suitable thickness may be utilized.

Additionally, the third slab 315 may be made from a similar material as the first slab 311 and the second slab 313. In such an embodiment the third slab 315 may be formed using a separate photolithographic masking and etching process from the first slab 311 and the second slab 313, or else may be formed using a combination of masking and etching processes that are also used to form the first slab 311 and the second slab 313. Any suitable combination of processes may be used to form the third slab 315.

In another embodiment the third slab 315 may be formed using a different material than the first slab 311 and the second slab 313. For example, in embodiments in which the first slab 311 comprises silicon, the third slab 315 may be a material such as silicon (Si), silicon nitride, polyimide, combinations of these, or the like. In such an embodiment the first slab 311 may be formed first as described above, and then the material for the third slab 315 may be deposited using a process such as chemical vapor deposition, physical vapor deposition, or atomic layer deposition, and patterning using one or more photolithographic masking and etching processes. However, any suitable materials and processes may be utilized.

Additionally, as best seen in the top-down view of FIG. 3B, the third slab 315 may have a diamond shape around the second slab 313 (which also has a diamond shape), with tapered sides on both sides of the interface between the sidewalls of the third slab 315. In an embodiment the third slab 315 may have a fourth width W₄ that is greater than the third width W₃, such as being between about 10 nm and about 10 μm, such as a few micrometers. However, any suitable dimensions may be utilized.

Returning now to FIG. 3B, once the converted optical signals have exited the rotator section 307, the optical signals enter the splitter section 309. In an embodiment the splitter section 309 comprises a first waveguide 317 and a second waveguide 319 separated by a first gap 321, such that the optical signals can be evanescently coupled between the first waveguide 317 and the second waveguide 319. In a particular embodiment the first waveguide 317 and the second waveguide 319 may be close enough to evanescently couple for a second length L₂ of between about 1 μm and about 5 mm. However, any suitable dimension may be utilized.

FIG. 3D illustrates a cross-sectional drawing of the splitter section 309 along line D-D′ in FIG. 3B. As can be seen in this figure, the first waveguide 317 and the second waveguide 319 may have a fourth thickness T₄ that is the same thickness with each other and the first thickness T₁. In a particular embodiment, the fourth thickness T₄ may be between about 10 nm and about 10 μm, such as about 50 nm and about 500 nm. However, in other embodiments the first waveguide 317 and the second waveguide 319 may have different thicknesses. Any suitable thicknesses may be utilized.

Additionally, in this view can be seen the third slab 315 as it surrounds the first waveguide 317 and the second waveguide 319. In an embodiment the third slab 315 in this embodiment may be thicker than the third slab 315 in the rotator section 307. For example, the third slab 315 in the splitter section 309 may have a fifth thickness T₅ of between about 10 nm and about 10 μm, such as between about 50 nm and about 500 nm. However, any suitable thickness may be utilized.

In an embodiment the first waveguide 317, the second waveguide 319, and the third slab 315 may be formed from the same material (e.g., silicon) or else may be formed of different materials. For example, in an embodiment in which the first waveguide 317, the second waveguide 319 and the third slab 315 are the same material, a combination of photolithographic masking and etching processes may be utilized. In other embodiments in which the first waveguide 317, the second waveguide 319, and the third slab 315 are different materials, a combination of photolithographic masking and etching processes along with deposition processes may be utilized. Any suitable processes and materials may be utilized, and all such combinations are fully intended to be included within the scope of the embodiments.

Returning now to the top-down view of FIG. 3B, the first waveguide 317 may have a decreasing tapered shape as it extends between the rotation section 307 and a section with a constant width (e.g., an exit to other waveguides). In an embodiment the first waveguide 317 may taper from the second width W₂ to a fifth width W₅ of between about 10 nm and about 10 μm, such as a few hundred nanometers. However, any suitable width may be utilized.

The second waveguide 319, instead of having a decreasing tapered shape, has an increasing tapered shape as a distance from the rotation section 307 is increased. In an embodiment the second waveguide 319 may taper from a sixth width W₆ of between about 10 nm and about 10 μm, such as less than a few hundred nm, to a seventh width W₇ of between about 10 nm and about 10 μm, such as a few hundred nanometers. However, any suitable widths may be utilized.

Finally, the first waveguide 317 and the second waveguide 319 may be separated by the first gap 321. In an embodiment the first gap 321 may separate the first waveguide 317 and the second waveguide 319 by a third distance D₃ of between about 10 nm and about 1 μm, such as between about 50 nm and about 300 nm. Further, once the first waveguide 317 and the second waveguide 319 separate such that the first waveguide 317 is not evanescently coupled to the second waveguide 319, the first waveguide 317 may be separated from the second waveguide 319 by a fourth distance D₄ of between about 1 μm and about 1 mm. However, any suitable dimensions may be utilized.

In operation, the optical signals (e.g., light with a wavelength belonging to the O-band or C-band, such as having wavelengths of 1310 nm or 1550 nm) will enter the rotator section 307 with multiple modes, such as the TM mode and the TE mode, as illustrated in the box labeled 323. The rotator section 307 receives the optical signals and converts the TM mode into the TE mode (although there may still be some residual TM mode present) with an improved conversion efficiency, as illustrated by the box labeled 325. Once the conversion has been achieved by the rotator section 307, the converted optical signals will then enter the splitter section 309, wherein the converted optical signals have TE mode, and the converted optical signals will be coupled into both the first waveguide 317 and the second waveguide 319 with the optical signals leaving the splitter section 309 with only the TE mode, as illustrated by the boxes labeled 327. Once split, the first waveguide 317 and the second waveguide 319 can then route the converted optical signals around a remainder of the device.

FIGS. 3E and 3F illustrate the remaining TM intensity for a normalized transmission in dB. In particular, FIG. 3E illustrates the remaining TM intensity through the second slab 313, with the x-axis being measured in micrometers. Similarly, FIG. 3F illustrates the remaining TM intensity through the third slab 315 in the splitter section 309, with the x-axis being measured in nanometers.

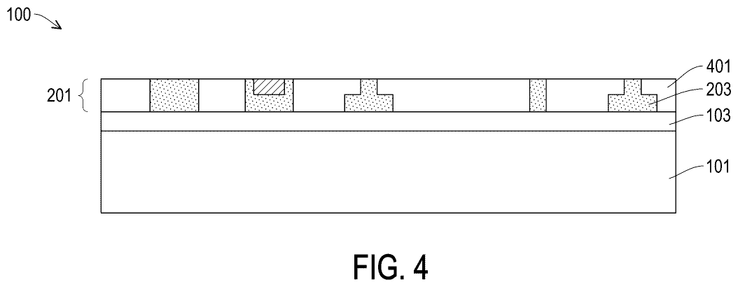

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, other low-k oxides, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

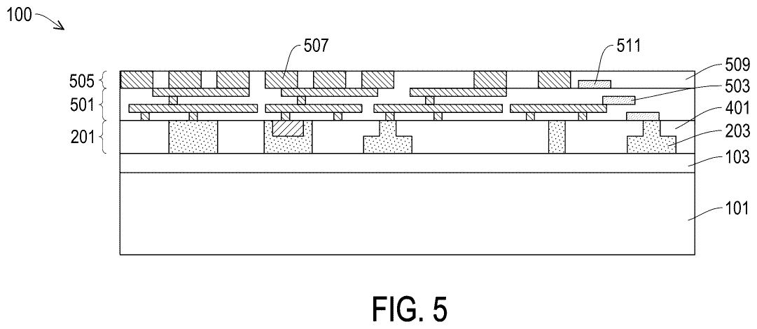

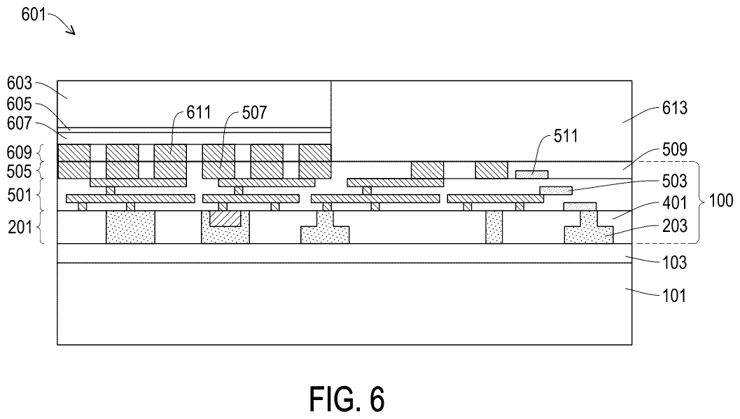

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as another one of the first photonic devices 303, couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the first semiconductor device 601. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

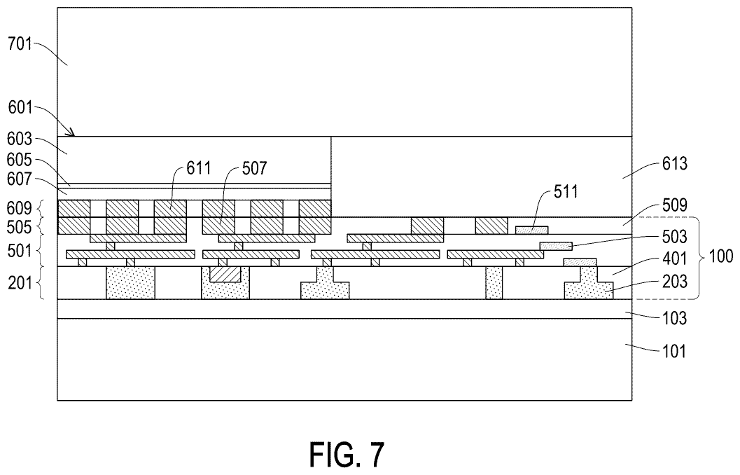

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

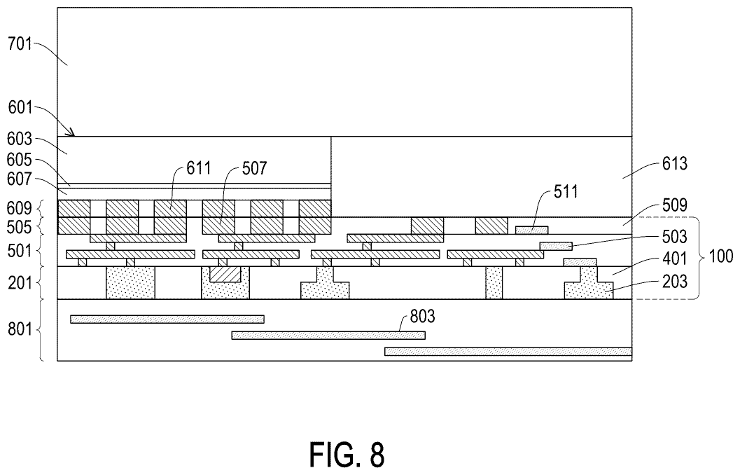

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

FIG. 9 illustrates formation of first through device vias (TDVs) 901 and formation of a third bonding layer 903 to form a first optical package 900 which, in some embodiments is a compact universal photonic engine (COUPE). In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

FIG. 9 additionally illustrates a placement of first external connectors 913 which may be formed to provide conductive regions for contact between the third bond pads 909 to other external devices. The first external connectors 913 may be conductive bumps (e.g., C4 bumps, ball grid arrays, microbumps, etc.) or conductive pillars utilizing materials such as solder and copper. In an embodiment in which the first external connectors 913 are contact bumps, the first external connectors 913 may comprise a material such as tin, or other suitable materials, such as silver, lead-free tin, or copper. In an embodiment in which the first external connectors 913 are tin solder bumps, the first external connectors 913 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Of course, while the use of first external connectors 913 is one embodiment which may be used in order to provide connections for the first optical package 900, this is intended to be illustrative and is not intended to limit the embodiments. Rather, any suitable method of physically, electrically, and in some cases optically connecting the first optical package 900, such as dielectric-to-dielectric and metal-to-metal bonding, may also be utilized. Any suitable method of bonding the first optical package 900 may be used.

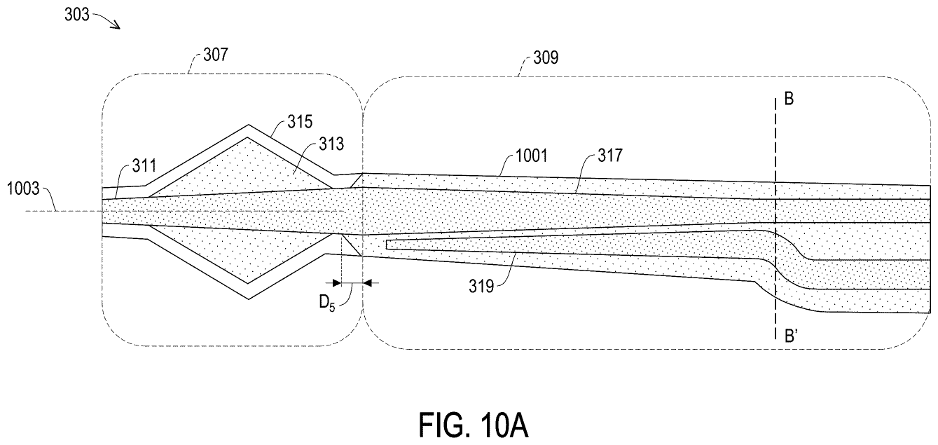

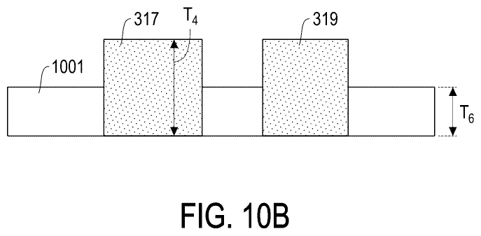

FIG. 10A illustrates another embodiment of the first photonic device 303 that is similar to the first photonic device 303 illustrated and discussed above with respect to FIGS. 3A-3D. In this embodiment the first slab 311, the second slab 313, and the third slab 315 located within the rotation section 307 are the same as described above with respect to FIG. 3B. In this embodiment, however, the third slab 315 does not extend into the splitter section 309. Rather, a fourth slab 1001 is located within the splitter section 309 around the first waveguide 317 and the second waveguide 319.

FIG. 10B illustrates a cross sectional view of FIG. 10A through line B-B′ in FIG. 10A. As can be seen in this figure, while the first waveguide 317 and the second waveguide 319 may be formed as described above with respect to FIGS. 3A-3B, in an embodiment the fourth slab 1001 may be formed to have a sixth thickness T₆ that is either the same as or different from (e.g., greater than) the third thickness T₃ and/or the fifth thickness T₅. In a particular embodiment, the sixth thickness T₆ may be between about 0 nm and about T₄ (0≤T₆≤T₄). However, any suitable thickness may be utilized.

Returning now to FIG. 10A, optionally in this embodiment an interface between the fourth slab 1001 and the third slab 315 is irregular. For example, in an embodiment the interface between the fourth slab 1001 and the third slab 315 is not perpendicular to a centerline 1003 running through the first slab 311. Additionally, the interface may extend a fifth distance D₅ parallel to the centerline running through the first slab 311, wherein the fifth distance D₅ may be between about 1 nm and about 1 mm. However, any suitable distance may be utilized.

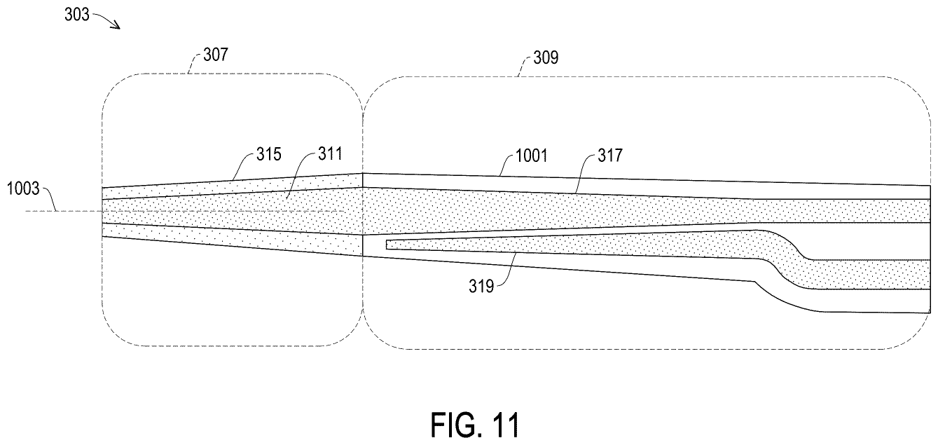

FIG. 11 illustrates another embodiment of the first photonic device 303 that is similar to the embodiment illustrated above with respect to FIGS. 10A-10B. In the embodiment illustrated in FIG. 11, however, the rotator section 307 comprises the first slab 311 and the third slab 315, but does not include the second slab 313. Additionally in this embodiment, the splitter section 309 comprises the fourth slab 1001 which shares the interface with the third slab 315.

In this embodiment, however, the interface between the fourth slab 1001 and the third slab 315 may or may not be orientated similarly to the orientation illustrated in FIG. 10A. Rather, while the interface between the fourth slab 1001 and the third slab 315 may be non-perpendicular with the centerline of the first waveguide 317, the interface may alternatively be perpendicular with the centerline of the first waveguide 317. Any suitable orientation of the interface may be used.

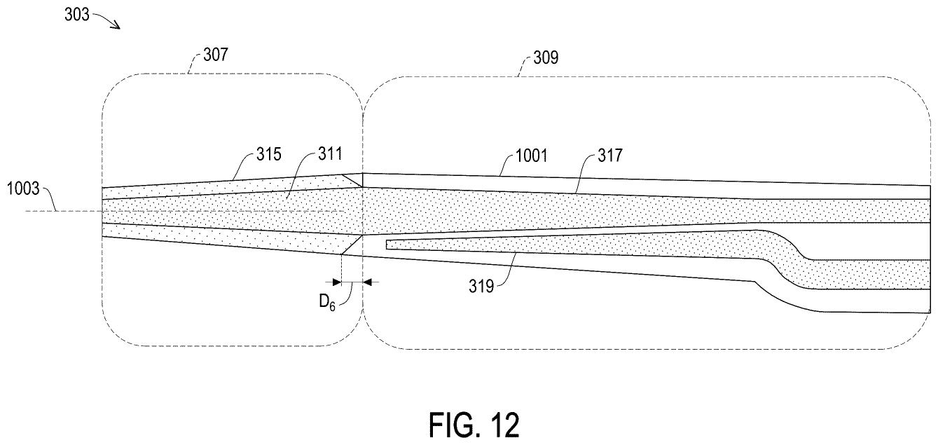

FIG. 12 illustrates another embodiment similar to the embodiment illustrated above with respect to FIG. 11, wherein the rotation section 307 includes the first slab 311 and the third slab 315 but does not include the second slab 313. In this embodiment, however, the interface between the fourth slab 1001 and the third slab 315 is also irregular. For example, in an embodiment the interface between the fourth slab 1001 and the third slab 315 is not perpendicular to the centerline 1003 running through the first slab 311, and a portion of the fourth slab 1001 extends into the rotation section 307. Additionally, the interface may extend a sixth distance D₆ parallel to the centerline running through the first slab 311, wherein the sixth distance D₆ may be between about 1 nm and about 1 mm. However, any suitable distance may be utilized.

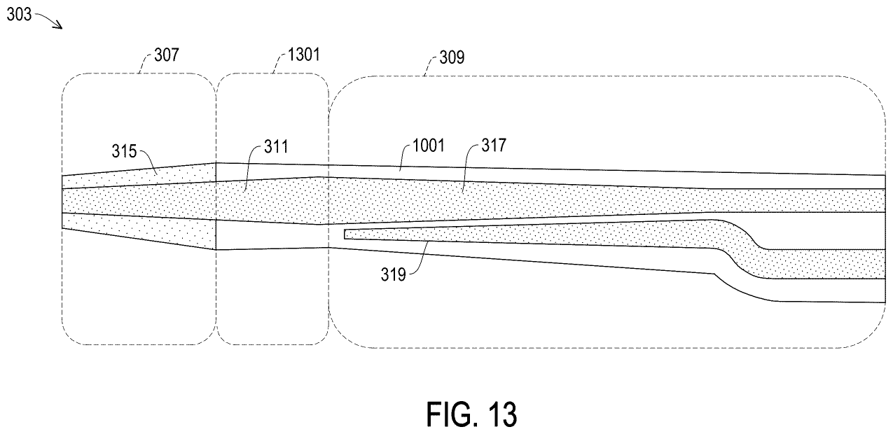

FIG. 13 illustrates yet another embodiment that is similar to the embodiment illustrated above with respect to FIG. 11, wherein the rotation section 307 includes the first slab 311 and the third slab 315 but does not include the second slab 313. Additionally, in this embodiment the interface between the fourth slab 1001 and the third slab 315 is perpendicular to the centerline of the first waveguide 317. However, any suitable orientation may be utilized.

In the embodiment illustrated in FIG. 13, however, there is a transition section 1301 located between the rotator section 307 and the splitter section 309. In an embodiment the first slab 311 within the transition section 1301 tapers as the first slab 311 extends away from the rotator section 307 until the first slab 311 reaches the desired second width W₂. However, the third slab 315 does not extend into the transition section 1301 with the first slab 311. Rather, the third slab 315 remains within the rotator section 307, and the fourth slab 1001 extends into the transition section 1301 to surround the first slab 311 in the top down view of FIG. 13.

By utilizing the first photonic device 303 as described above with respect to FIGS. 1-13, the first photonic device 303 can be disposed in a receiver and configured to convert the light transmission mode of a light source received by the receiver. Additionally, by using the embodiments disclosed herein the overall efficiency of the conversion of the light transmission mode can be improved. As such, the overall insertion loss of the optical signals can be lower than about 1 dB.

Additionally, while many embodiments have been described herein to illustrate the various ideas that are being presented, the particular embodiments presented are not intended to limit the ideas to the particular embodiments discussed. Rather, the ideas presented can be applied in a wide range of ways, including additional structures and/or applications. For example, in other embodiments, other layers such as semiconductor layers, metal layers, oxide layers, etc., may be stacked over the first photonic device 303 wherein there is an air gap located between the first photonic device 303 and the overlying layers. Any suitable structures and any suitable methods may be utilized, and all such structure and methods are fully intended to be included within the scope of the embodiments.

In an embodiment, a method of manufacturing an optical device includes: forming a rotation section, the forming the rotation section including: forming a first slab with a first thickness; forming a second slab with a second thickness different from the first thickness; and forming a third slab with a third thickness different from the first thickness and the second thickness; and forming a splitter section adjacent to the rotation section. In an embodiment the forming the splitter section includes: forming a first waveguide; and forming a second waveguide coupled to the first waveguide. In an embodiment the forming the third slab forms the third slab with the third thickness adjacent to the first waveguide and the second waveguide. In an embodiment the method further includes forming a fourth slab adjacent to the first waveguide and the second waveguide, the fourth slab having a fourth thickness different from the third thickness. In an embodiment an interface between the fourth slab and the third slab is misaligned with a line that is perpendicular with a centerline of the first slab. In an embodiment an interface between the fourth slab and the third slab is perpendicular with a centerline of the first slab. In an embodiment the first thickness is greater than the second thickness and wherein the second thickness is greater than the third thickness.

In another embodiment, a method of manufacturing an optical device, the method including: forming an optical signal rotator, the optical signal rotator comprising a first slab and a second slab with different thicknesses from each other; and forming a splitter adjacent to the optical signal rotator. In an embodiment the optical signal rotator comprises a third slab with a thickness different from both the first slab and the second slab. In an embodiment the method further includes forming a transition region between the optical signal rotator and the splitter, wherein the transition region comprises a portion of the first slab and a portion of a fourth slab, the fourth slab extending into the splitter. In an embodiment an interface between the fourth slab and the second slab is misaligned with a line that is perpendicular with a centerline of the first slab. In an embodiment an interface between the fourth slab and the second slab is perpendicular with a centerline of the first slab. In an embodiment the first slab has a first thickness of between about 10 nm and about 10 μm. In an embodiment the first slab has a first thickness of between about 50 nm and about 500 nm.

In yet another embodiment an optical device includes: a rotation section, the rotation section including: a first slab with a first thickness; and a second slab with a second thickness different from the first thickness; a splitter section, the splitter section including: a first waveguide; and a second waveguide coupled to the first waveguide. In an embodiment the rotation section further comprises a third slab with a third thickness different from the first thickness and the second thickness. In an embodiment the third slab has a diamond shape around the first slab. In an embodiment the first thickness is between about 10 nm and about 10 μm. In an embodiment the first thickness is between about 50 nm and about 500 nm. In an embodiment the splitter section comprises a third slab with a third thickness different from the first thickness and the second thickness.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device comprising:
a rotation section comprising:
a first slab with a first thickness;
a second slab with a second thickness different from the first thickness; and
a third slab with a third thickness different from the first thickness and the second thickness; and
a splitter section adjacent to the rotation section.

2. The optical device of claim 1, wherein the first thickness is between about 10 nm and about 10 μm.

3. The optical device of claim 2, wherein the first slab has a first length of between bout 1 μm and about 5 mm.

4. The optical device of claim 1, wherein the first slab has a tapered shape.

5. The optical device of claim 1, wherein the second thickness is between about 10 nm and about 10 μm.

6. The optical device of claim 1, wherein the first slab comprises a first material and the second slab comprises the first material.

7. The optical device of claim 1, wherein the first slab comprises a first material and the second slab comprises a second material different from the first material.

8. An optical device comprising:
an optical signal rotator, the optical signal rotator comprising a first slab and a second slab with different thicknesses from each other; and
a splitter adjacent to the optical signal rotator.

9. The optical device of claim 8, wherein the first slab has a thickness of between about 50 nm and about 500 nm.

10. The optical device of claim 8, wherein the second slab has a thickness of between about 50 nm and about 500 nm.

11. The optical device of claim 8, wherein the first slab and the second slab are different materials.

12. The optical device of claim 8, wherein the second slab has a diamond shape.

13. The optical device of claim 8, wherein the second slab has a width of between about 10 nm and about 10 μm.

14. The optical device of claim 8, further comprising a third slab adjacent to the second slab, the third slab having a different thickness than both the first slab and the second slab.

15. An optical device comprising:
a rotation section, the rotation section comprising:
a first slab with a first thickness;
a second slab with a second thickness different from the first thickness; and
a third slab with a third thickness different from both the first thickness and the second thickness; and
a splitter section, the splitter section comprising:
a first waveguide;
a second waveguide coupled to the first waveguide; and
a fourth slab around the first waveguide and the second waveguide, the fourth slab being different from the first slab, the second slab, and the third slab.

16. The optical device of claim 15, wherein an interface between the fourth slab and the third slab is not perpendicular to a centerline running through the first slab.

17. The optical device of claim 15, wherein the first thickness is between about 10 nm and about 10 μm.

18. The optical device of claim 15, wherein the second thickness is between about 10 nm and about 10 μm.

19. The optical device of claim 15, wherein the fourth slab has a fourth thickness that is less than a fifth thickness of the first waveguide.

20. The optical device of claim 15, wherein the fourth slab has a fourth thickness that is greater than the third thickness.
